(19) United States
(12) Patent Application Publication
(10) Pub. No.: US 2007/0067531 A1
(43) Pub. Date: Mar. 22, 2007

(54) Multi-master interconnect arbitration with time division priority circulation and programmable bandwidth/latency allocation

(76) Inventors: Pasi Kolinummi, Kangasala (FI); Mika Koikkalainen, Tampere (FI); Juhani Vehvilainen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/210,153

(22) Filed: Aug. 22, 2005

(51) Int. Cl. G06F 13/00; G06F 13/14

(52) U.S. Cl. 710/240; 710/111

(57) ABSTRACT

A method and apparatus are provided to arbitrate multiple master requests to a shared resource, featuring a step of combining two different ways to arbitrate the multiple master requests to the shared resource in an operation independent manner. The two different ways may include a priority arbitration technique and a round robin arbitration technique. The priority arbitration technique may include a time division priority selection technique. The shared resource may include a set of one or more peripherals and/or memories. The step may be implemented in an application specific integrated circuit (ASIC) or other suitable application environment, which includes video, graphic, cellular or other suitable functionality.

### BACKGROUND OF THE INVENTION

1. Technical Field

The present invention relates to a method and apparatus to arbitrate multiple master requests to a shared resource.

In particularly, the present invention belongs to the hardware implementation of interconnected structures and especially for arbitration in front of common resources. Integrated circuits have many functional parts, which usually are connected to the same set of peripherals or memories. A common external memory interface is a good example and is used as the main example to describe the present invention. Many devices want to have access to external memory and they need the access “all the time”. Since there is only one external interface, incoming operations have to be pipelined in some manner. This many-to-one (could be many-to-many as well) mapping is the key issue in the present invention. The importance of arbitration is increased together with more complex hardware sharing the same resource like video, graphics and cellular phone.

The invention also describes an ASIC implementation for an arbitration module, but basically the arbitration does not need to be inside the ASIC i.e. the concept is applicable in other environments as well.

2. Description of Related Problem

Different arbitration methods have been suggested in the art. Round robin and priority-based arbitrations are the most common ones. Round-robin arbitration gives fair arbitration and thus good bandwidth utilization as well. All time slots are used as well as operations are not split into small parts. This is a good arbitration method, but it does not offer any differentiation between a master's real time requirements.

A priority based method is usually used to differentiate real time requests and other requests. If there is only a few priority based masters with reasonably slow bandwidth requirement, this method works reasonably well. However, when the number of masters with real time requirements is increasing, they can block the whole interface and in a worst-case cause a so-called deadlock situation. In addition, the latency times in the priority masters are again increasing since priority masters are arbitrated in a round robin manner. This method does not allow any control for bandwidth allocation.

There are also solutions where these methods are combined in one way or another. For example, one known way is to define a few categories (different priorities), arbitrate the masters in a round-robin manner within the same priority group and then use priority-based arbitration between different groups. This method allows more groups with different priority. However, the priority groups are fixed in hardware (HW) and the selections have to be made in ASIC development time. Some configurability can be added also on this method to somewhat tune the design in product development time. A lower priority port blocking issue as well as difficulties in counting the worst-case latency are still there. Thus the combinations do not solve the issue, but can shift the sweep spot lightly to some direction. This might give a reasonable solution when the requirement and the master behavior is well known in system design time.

Another known method is to use a time-out based priority arbitration scheme. In this method, masters have different programmable time-out values. Time-out values are soft limits to increase the master priority for the operations that are waiting for service. The idea is to increase the priority until the operation is done. When there is one master with a time-out priority, it is quite easy to count a worst-case latency. Latency increases if there are more masters with priority. In addition, already two masters with a time-out priority can in theory block all other operations and cause a deadlock situation.

A time division multiplexing (TDM) technique is also known in the art. In this technique, the time division is fixed and masters have to time line their operations to selected frames. This might work in fixed hardware, which executes one task similarly each time. However, normal systems do not operate so predictably since the operations are based on variable data or external intervention like user operations. Thus it has been noticed that this method does not work in processor systems. Resource utilization is quite bad since unused TDM frames cannot be used at all. If the master, who has a turn, does not have anything to transfer, the slot is empty and others cannot use it. TDM and competition based arbitration can be used together, but in the end TDM slots didn't have users and more or less only competition based arbitration is used.

However, none of the aforementioned methods solves the case well enough for mobile handset requirements. Handsets require predictable worst-case latency without blocking any masters. There could be simultaneous hard real time requirements (e.g. a phone call with network synchronization) in one part of the system, while another part is doing non-real time operations (e.g. displaying user text in the display. The behavior of the masters is application/product dependent and thus the arbitration cannot be fixed in design time. For that reason, it was mandatory to develop a more flexible arbitration for multi-master devices, which support multiple simultaneous applications

### SUMMARY OF THE INVENTION

In its broadest sense, the present invention provides a new and unique method and apparatus to arbitrate multiple master requests to a shared resource, featuring a step or technique of combining two different ways to arbitrate the multiple master requests to the shared resource in an operation independent manner. The two different ways may include a priority arbitration technique and a round robin arbitration technique. The priority arbitration technique may include a time division priority selection technique. The shared resource may include a set of one or more peripherals and/or memories. The step or technique may be implemented in an application specific integrated circuit (ASIC) or other suitable application environment, which provide video, graphic, cellular or other suitable functionality.

In effect, the present invention provides a new method and apparatus to arbitrate multiple master requests to one or more shared resources that solves a problem, where masters have different requirements in terms of operation latency and the number of requests to be processed. In the case of a memory interface, this can be considered as a memory bandwidth requirement and access latency requirement. The arbitration mechanism utilizes a time division method to change priority between each master or actually between each thread. A master can have a single thread or multiple threads. Threads are independent and they can be arbitrated between one another. However, if threads come from the same port, then the interconnect may need to have a buffer memory to allow arbitration in that port. In the simplest implementation, requests from one port are handled sequentially.

Basically, the arbiter will operate in a round-robin manner i.e. the arbiter performs the operation thread after thread. Each thread will get its turn. If there are N threads, one thread gets its turn in every Nth cycle. This is a well-known round-robin arbitration technique. However, the round robin technique does not give well enough real time response i.e. a latency response in all cases. This problem has been found out in a known modem ASIC. For that reason some threads need a priority over the others. The invention combines priority arbitration and round robin arbitration in an operation independent manner and allows programmable bandwidth/latency allocation to each thread. The allocation can be dynamically varied at run time.

In the main embodiment, time division for priority selection is used, which is independent of the incoming request. Request independent priority selection allows a separate priority generation and arbitration. Priority thread identification is just one input of the arbiter. Time division priority generation gives full flexibility to allocate bandwidth between threads in run time. At the same time, the round robin logic prevents blocking some threads, which is the usual problem in priority arbitration. Arbitration does not lose any bandwidth since round robin arbitration is always used if any of the threads do not match to the current priority thread identification.

The arbiter operation in short is as follows:

The arbiter checks if any thread matches to the current priority thread identification. If there is a match, then the arbiter will select a priority thread. As long as the thread matches to the priority identification that thread is executed. If no thread matches to the priority thread identity, then the arbiter arbitrates threads in a circular fashion (round robin).

At the same time, the priority thread identification will change in each time slot (time division). The time division priority change guarantees that masters get their turn after a certain time period, i.e. this guarantees the worst case latency for master operation. In most cases, a master will get a turn already before it's priority turn. Thus the normal operation condition is close to round robin arbitration, but it has a special capability to guarantee worst-case latency. Latency and bandwidth are very similar terms in this context and thus it also guarantees worst-case bandwidth. To guarantee latency/bandwidth in all conditions is a mandatory requirement for real time systems like cellular phones.

The present invention also gives additional flexibility to divide priority slots of a thread as multiple small slots that can be located sequentially or distributed over whole master frame. A master frame is a frame consisting of multiple priority slots and the master frame counter uses modulo arithmetic. Distributed priority slots give a shorter maximum latency time, which is important for devices that cannot transfer a big block of data at once. Examples include many hardware accelerators and processor cores which reach better performance and real time responses.

The key issues addressed in the present invention are as follows:

Programmable maximum latency/minimum bandwidth (BW) done with programmable priority generation between time slots;

Operation independent arbitration priorities, i.e. operations/ports do not have priority tags;

BW/Latency values are predictable which is mandatory requirement for hard real time systems (1 microsecond class real time requirement in one case);

BW allocation can be changed on the fly;

A simple implementation;

Time division based priority circulation (there is a big difference for time division arbitration, which is a known method);

Priority slots are programmable (e.g. the number and/or width);

Implementation is based on a master frame concept;

Full BW used all the time (if no access from a priority master, then round-robin used); and

Time slots can be allocated sequentially in one block or they can be distributed over to a whole master frame.

According to the present invention, the apparatus may take the form of a network node having a module for combining two different ways or techniques to arbitrate the multiple master requests to the shared resource in an operation independent manner, consistent with that described herein. The network node may take the form of a mobile phone, a mobile terminal, cellular headset, a personal digital assistant, a computer terminal, or other suitable user equipment.

The apparatus may also take the form of a network or system having a network node with a module for implementing the present invention.

The present invention may also take the form of a computer program product with a program code, which program code is stored on a machine readable carrier, for carrying out the steps of a method comprising the steps of: combining the two different ways or techniques to arbitrate the multiple master requests to the shared resource in an operation independent manner, when the computer program is run in a processor or control module of either user equipment, a network node, or some combination thereof, consistent with that described herein.

In operation, the present invention provides an effective usage of one or more shared resources, especially shared memories, which is the key target. The definition of effective is not that simple since there is usually two kinds of requirements, i.e. an average bandwidth requirement and real time response requirement. Usually operations are ordered and optimized to achieve a best possible bandwidth. In most cases, this makes sense since even with this definition, the real time requirement can be met. However, in a complex ASIC with video, graphics and cellular functionalities in the same chip with one external memory interface, the situation cannot be solved with pure bandwidth optimization since the cellular requirement, i.e. predictable memory access time, has to be met. The present invention gives predictability without sacrificing average memory bandwidth.

Moreover, the present invention gives a fair arbitration with predictable worst-case latency. Maximum latency can be selected based on a master's requirement. For that reason the same arbitration methods work with different products, which can use the hardware features differently. Arbitration prevents operation blocking. Software (SW) can define bandwidth allocation. The arbitration is completely system independent since latency/bandwidth allocation can be freely programmed. The present invention provides a method that can be used similarly with all ASICs, which offers a big improvement in hardware development. The enablers of this are priority circulated independent of the masters or the master operations. All earlier known solutions are based on the priority defined by the operation and the whole thrust of the present invention is to separate them from each other. This gives more possibilities as well as a common solution without any need for an exhaustive system design to find out the sweep spot in each system. The present invention effectively provides a first order solution for the problem, while the prior art described above are zero order solutions that operate in certain almost fixed operating point.

The foregoing and other objects, features and advantages of the present invention will become more apparent in light of the following detailed description of exemplary embodiments thereof.

### BRIEF DESCRIPTION OF THE DRAWING

The drawing is not drawn to scale and includes the following Figures:

FIG. 1 show a basic diagram of a network node according to the present invention.

FIG. 2 show a block diagram of system connections in the network node according to the present invention.

FIGS. 3(a), (b) and (c) show block diagrams of arbitration configurations according to the present invention.

FIG. 4 show a diagram of an example of a master frame and priority slot allocation according to the present invention.

FIG. 5 show an idea level state diagram of operations according to the present invention.

### BEST MODE FOR CARRYING OUT THE INVENTION

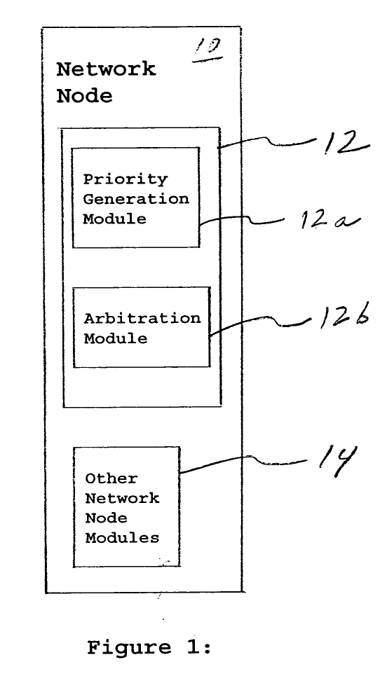

### FIG. 1: The Basic Invention

FIG. 1 shows, by way of example, a network node generally indicated as 10 that includes a module 12 and other network node modules 14, which include one or more masters or devices and one or more shared resources. The module 12 functions to arbitrate multiple master requests to the one or more shared resources. According to the present invention, the module 12 combines two different ways or techniques to arbitrate the multiple master requests to the one or more shared resources in an operation independent manner.

The module 12 may include a priority generation module 12a and an arbitration module 12b as shown, as well as other modules not shown which do not form part of the overall invention. The priority generation module 12a and arbitration module 12b may be separate modules or form part of a single module within the module 12. In the network node 10, the module 12 may take the form of, and/or may form part of, an application specific integrated circuit (ASIC) according to the present invention. The ASIC may perform video, graphic, cellular or other suitable functionality known in the art in the network node 10. However, it is important to note that the scope of the invention is not intended to be limited to where the module 12 is implemented in the network node 10.

In one embodiment, the two different ways or techniques include a priority arbitration technique and a round robin arbitration technique, consistent with that shown and described herein. Although the present invention is described using a combination of priority and round robin arbitration techniques, the scope of the invention is intended to include other combinations of arbitration techniques either now known or later developed in the future. Moreover, the priority arbitration technique may include a time division priority selection technique or other suitable priority selection technique either now known or later developed in the future.

The shared resource that forms part of module 14 may include a set of one or more peripherals and/or memories, as well as other shared resources either now known or later developed in the future. The one or more masters or devices in the network node 10 may include a camera sensor or other device needing access to the one or more peripherals and/or memories. The scope of the invention is not intended to be limited to any particular type or kind of master, device or shared resource. The whole thrust of the invention is to provide a new and unique method and apparatus to arbitrate multiple master requests to one or more shared resources that form part of module 14.

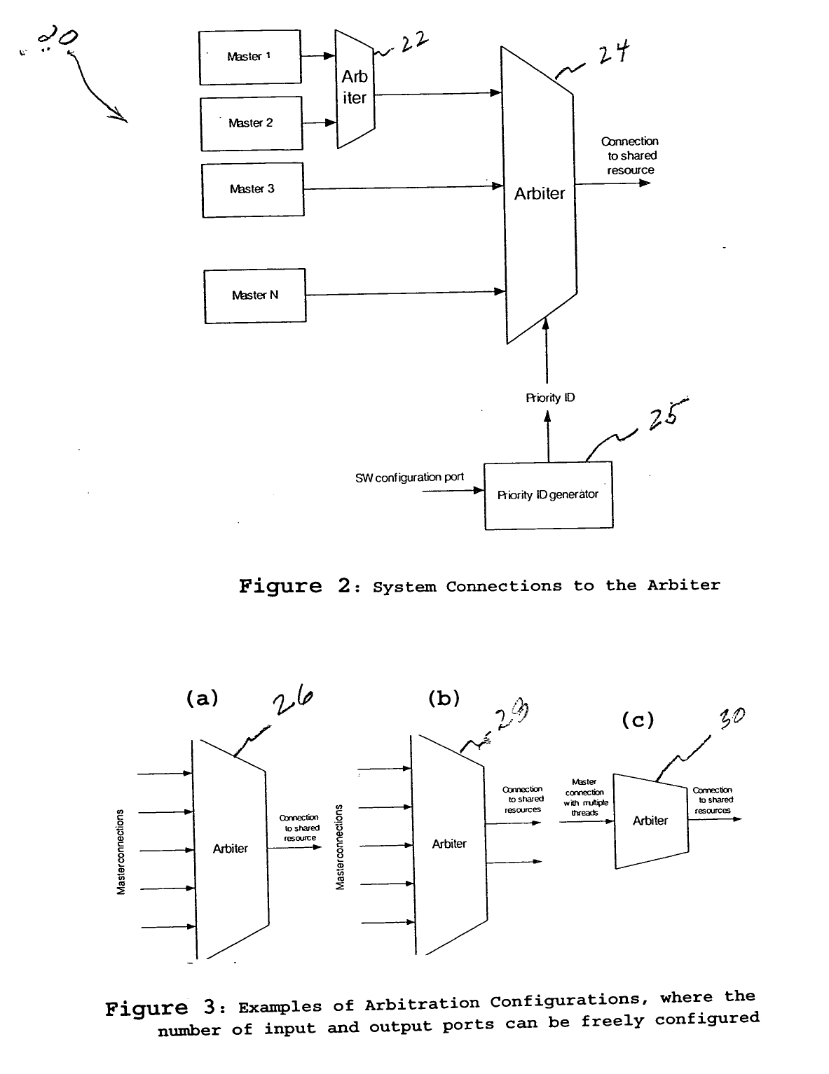

### FIG. 2: The Basic Implementation

FIG. 2 shows a block diagram of system connections generally indicated as 20 in the network node 10. The system connections 20 include Master1, Master2, . . . , MasterN, arbiters 22 and 24 and a priority ID generator 25. As shown, the Master1 and Master2 are connected to the arbiter 22, the Master3, Master4 and the arbiter 22 are connected to the arbiter 24, and the priority ID generator 25 is connected to the arbiter 24. In operation, the priority ID generator 25 responds to a software configuration port signal, and provides a priority ID signal to the arbiter 24. The arbiter 24 responds to the priority ID signal, and provides a connection from the Master1, Master2, . . . , MasterN to the shared resource.

FIGS. 3(a), (b) and (c) show block diagrams of arbitration configurations according to the present invention. FIG. 3(a) shows a configuration having multiple master connections to an arbiter 26 for a single connection to a shared resource. FIG. 3(b) shows a configuration having multiple master connections to an arbiter 28 for a pair of connections to a shared resource. FIG. 3(c) shows a configuration having a master connection with multiple threads to an arbiter 30 for a single connection to a shared resource. These configurations are shown by way of example, and the scope of the invention is not intended to be limited to any particular type or kind of configurations.

Consistent with that shown and described herein, the idea is to implement a time division priority selection. In operation, the priority identification (ID) is completely independent of the incoming access identifications. The access identifications can be master IDs or thread IDs, as shown in FIGS. 2-3. A single master can have multiple thread IDs. The system will support out-of-order responses, which allow freely ordering the incoming operations. It is preferable that also masters support multiple outstanding operations as well as out-of-order responses. This gives freedom for the arbitration logic to select the most suitable operation ordering.

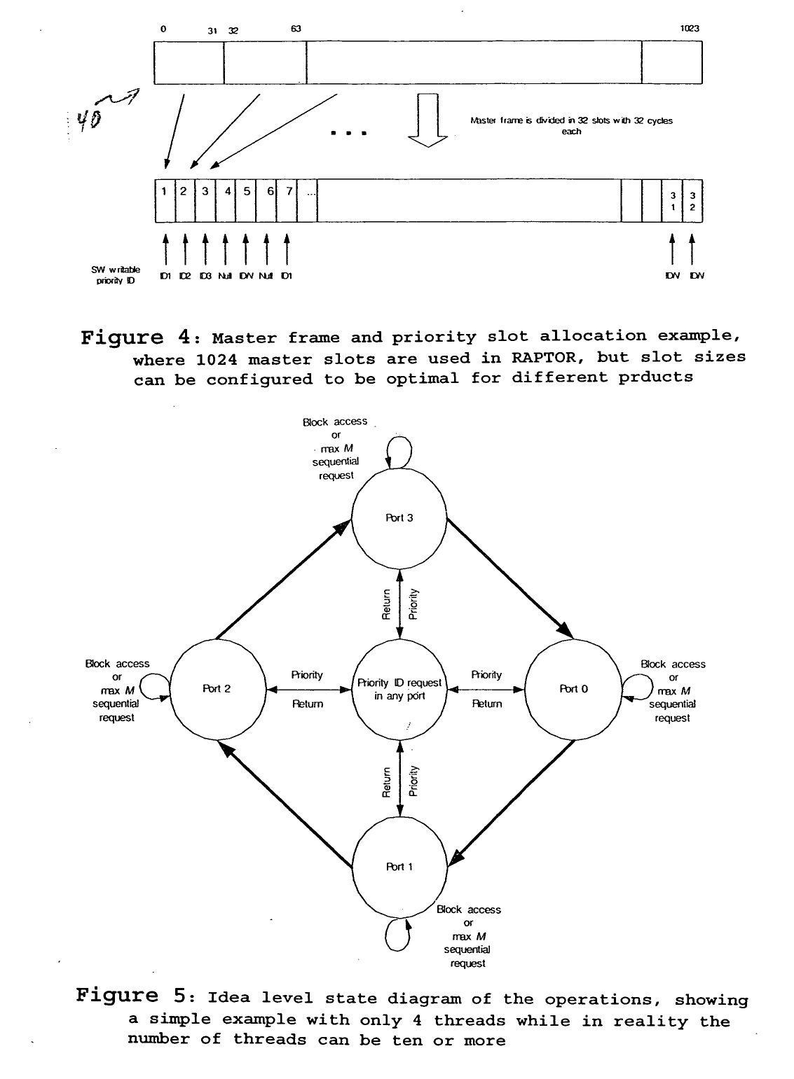

The priority generation module 12a and the arbitration module 12b are shown separated, but could be formed as single module if wanted). The priority generation module 12a has a configurable length master frame, which includes a variable number of priority slots. FIG. 4 shows a master frame 40 having 1024 slots. In theory, the slot size could be one clock cycle, but in practice longer priority slots are better. The priority slot should be long enough to allow at least one operation of the selected master ID if there is incoming request. Operations can take multiple cycles, which make it more reasonable to have at least a few memory cycles per priority slot. Logically connected operations like burst or packed accesses can be handled as a single packet or multiple operations. Single packet handling gives better result in our case and thus selected for implementation. The priority ID of each priority slot is freely programmable. Some masters IDs may have multiple slots, while others may not have any. When a master ID has a priority, it will get its turn. However, if there isn't any outstanding operation from that master ID, then round robin arbitration is used. Some priority slots do not have any priority and thus these slots are always used for round-robin arbitration.

Master ID minimum bandwidth allocation as well as maximum latency for operation can be selected based on priority slot selections. If a thread has one slot inside the master frame, then the maximum latency for that thread is the length of the master frame. If a thread has two slots that equally distributed, then the maximum latency is the master frame length divided by two and so on. Secured minimum bandwidth can be counted in a similar manner. The number of operations per priority slot is known and thus the minimum bandwidth is the number of slots times the operations per slot. In reality, the thread can get turn in the round-robin arbitration as well and thus the bandwidth can be larger than the secured bandwidth.

### The Implementation

The following is an example of an implementation:

### Implementation Requirements

The requirements are as follows:

1) Each device will get at least one access turn within master frame to avoid starving;

2) The number of device priority slots is programmable (Slots are equally distributed and thus the worst-case latency can be calculated from the number of slots and the master frame length); and

3) The burst operation is handled as one logical operation (The number of sequential single operations before the next port can be programmed by the software (SW)).

### The Particulars

In accordance with the present invention, the length of the master frame 40 is fixed into 1024 memory clock cycles. See FIG. 4. With 166 MHz SDRAM components this means 6.1 microsecond. The master frame 40 will have 32 slots, each of which are 32 cycles long. The master frame length as well as the number of slots is a generic feature of the module 12 and there is no need to fix them so the above are just an example of the configuration. All non-allocated slots in the master frame are used for round-robin arbitration. If no slots are allocated, a pure round-robin arbitration is used. When a certain slot is allocated to a certain master, the master gets priority during that time. For example, if the master has one slot allocated, it is guaranteed that access latency will be less than 6.1 microsecond. With two slots, a 3 microsecond latency time is guaranteed, and with 4 slots a 1.5 microsecond maximum memory access latency is guaranteed. If the master with priority does not have any outstanding operation, then the slot is used in a round-robin manner. Thus, a full SDRAM bandwidth is used in all cases and priority slots are used to guarantee a worst-case latency. In most cases, the latency times are much shorter than the worst-case latency.

The above example has master frame and priority slots that are directly tied to wall clock time. The same result can also be achieved with meters that are indirectly related to time. The main requirement is that the maximum length of the master frame is known. The length can vary but the limits need to be defined to allow system analysis. An alternative way is to count the number of memory operations. In that case, the master frame is defined as a maximum number of memory operations and priority slots are defined as N operations per slot. If/when the operation max and min times are known, the operation based definition can be changed to a time based operation.

An operation based approach allows easier optimization of priority slots since their time can be defined to be shorter. In a pure time base definition, a priority slot has to be long enough to make sure that the priority master can make at least one operation. In an operation based definition, a priority slot can be only one operation even though in a normal condition something along the lines of ten operations is likely to give a better result.

Another way to view this is to consider that slots are used to allocate memory bandwidth. For example, data transfer from a master device such as a camera sensor may need 50 megabits per second (MB/s) speed. By assuming the camera master has outstanding operations all the time, then the number of SDRAM cycles reserved for the camera can be counted based on the slot allocation. If two slots are allocated, it means that the camera will get at least 64 cycles within 1024 cycles. This gives 1/16 from the total effective bandwidth. Assuming 1 GB/s memory bandwidth, this gives 62.5 MB/s for the camera. The above calculations is based an assumption that the memory auto refresh has a minimal effect, which is true in current SDRAM components. In addition, the bandwidth allocation can be a little bit different if masters use different burst size. Since burst operations are always completed, previous burst operation could take a few clock cycles from the next one. While description monitors master burst information, there is an alternative and more general method to do that. The method is based on the correlation between sequential requests. When the samples are correlated, no arbitration is performed. This illustrates situations like reading from addresses 1, 2, 3, 4, etc., i.e. operations can be single accesses but they have a strong correlation. Maximum correlation is needed because memory devices usually, and especially SDRAM, operate fast with spatially located data since it has buffers that can be accessed fast. Memory can also open a new page at the same time as another page is read. Thus the most optimal case is to open another buffer while reading the first, and thus change the buffer immediately if there will be a need to open a new one, i.e. there is always a suitable buffer open. Variation of different masters can be taken into account for slot allocation if the masters have radically different burst operations. In most systems, average bandwidth allocation is very close to theoretical without any compensation.

### Implementation of Module 12, 12a, 12b

By way of example, the functionality of the modules 12, 12a and/or 12b shown in FIG. 2 may be implemented using hardware, software, firmware, or a combination thereof, although the scope of the invention is not intended to be limited to any particular embodiment thereof. In a typical software implementation, such a module may include one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the one or more modules shown in FIG. 2 being stand alone modules for implementing their respective functionality, as well as one module for implementing the functionality of the modules in the combination, or in combination with other circuitry for implementing the same.

The other network modules 14 and the functionality thereof are known in the art, do not form part of the underlying invention per se, and are described in detail herein to the extent needed to understand the present invention.

### Advantages

Advantages of the present invention include the following:

Programmable maximum latency/minimum bandwidth (BW) (i.e. programmable latency/bandwidth allocation);

Operation independent arbitration priorities i.e. operations/ports do not have priority tags;

Simple system independent method i.e. system behavior does not affect on hardware implementation;

BW/Latency values are predictable which is mandatory requirement for hard real time systems (1 microsecond class real time requirement in a desired case);

Time division based priority circulation (Arbitration is round-robin (fair) all the time except the one with priority);

Priority slots are programmable (e.g. the number and/or width);

Full BW used all the time (if no access from priority master, then round-robin for others); and

Shorter average latency will improve many devices including HW accelerator (e.g. video), shorter average latency is achieved multiple small slots compared to one long slot.

### Other Applications

The present invention can be used in numerous applications or locations, even though it is only described above in relation to external memory interface. Similar issues are arising in the industry when attempts are made to integrate an application ASIC and cellular modem on the same chip. Even in pure application ASICs, the same problems are encountered. Their implementation are currently much worse than the proposed implementation. In any case, the problem solved in the present invention will be very important for the state of the art and is clearly the key component in a cellular handset memory optimisation, which is the key interface to get good performance out of the system.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. A method to arbitrate multiple master requests to a shared resource, characterized in that the method comprises
a step of combining two different ways to arbitrate the multiple master requests to the shared resource in an operation independent manner.

2. A method according to claim 1, wherein the two different ways comprise a priority arbitration technique and a round robin arbitration technique.

3. A method according to claim 2, wherein the priority arbitration technique comprises a time division priority selection technique.

4. A method according to claim 1, wherein the shared resource includes a set of one or more peripherals and/or memories.

5. A method according to claim 1, wherein the method is implemented in an application specific integrated circuit (ASIC) or other suitable application environment.

6. A method according to claim 5, wherein the functionality of application specific integrated circuit (ASIC) or other suitable application environment includes video, graphic, cellular or other suitable functionality.

7. A method according to claim 1, wherein the step of combining includes allowing programmable bandwidth/latency allocation to each thread.

8. A method according to claim 7, wherein the programmable bandwidth/latency allocation can be dynamically varied at run time.

9. A method according to claim 7, wherein the operation independent manner includes using time division for priority allocation which is independent of incoming requests, including the priority defined by the operation.

10. A method according to claim 1, wherein the method includes using a first arbitration technique if a current priority parameter of a second arbitration technique does not match.

11. A method according to claim 10, wherein a round robin arbitration is used if any thread does not match a current priority thread identification in a time division priority selection technique.

12. A method according to claim 3, wherein the time division priority selection technique includes changing in each time slot the priority thread identification so that masters get their turn after a certain period of time.

13. A method according to claim 3, wherein the time division priority selection technique includes dividing priority slots of a thread as multiple small slots that can be located sequentially or distributed over a whole master frame.

14. A method according to claim 3, wherein the time division priority selection technique includes using a master frame having multiple slots.

15. A method according to claim 14, wherein the master frame includes some slots that do not have any priority and thus are used for the round robin arbitration technique.

16. A method according to claim 14, wherein the master frame is configurable and includes having a variable number of priority slots.

17. A method according to claim 14, wherein the master frame includes slot sizes that are either one clock cycle, or longer clock cycles to allow at least one operation of a selected master identification, or multiple clock cycles for handling burst or packeted accesses as a single packet or multiple operations, or some combination thereof.

18. A method according to claim 14, wherein the master frame includes time slots having respective priority identification that are freely programmable, including some master identifications with multiple time slots and others with no time slots.

19. A method according to claim 14, wherein the master time frame includes multiple priority slots that are programmable in relation to their number, width or other suitable priority slot parameter.

20. A method according to claim 1, wherein the method includes selecting a maximum/minimum latency, a maximum/minimum bandwidth, or some combination thereof based on a master's requirements.

21. A method according to claim 3, wherein the time division priority selection technique includes using a priority identification (ID) that is independent of incoming access identifications.

22. A method according to claim 3, wherein the incoming access identifications include a master identification (ID), a thread identification, or some combination thereof.

23. A method according to claim 22, wherein a single master has multiple thread identifications (IDs).

24. A method according to claim 1, wherein the method includes supporting out-of-order responses, which allows freely ordering incoming operations.

25. A method according to claim 22, wherein the method includes using the round robin arbitration technique if there is no outstanding operation for the master identification (ID).

26. A network node having a module to arbitrate multiple master requests to a shared resource, characterized in that the module combines two different ways to arbitrate the multiple master requests to the shared resource in an operation independent manner.

27. A network node according to claim 26, wherein the two different ways comprise a priority arbitration technique and a round robin arbitration technique.

28. A network node according to claim 27, wherein the priority arbitration technique comprises a time division priority selection technique.

29. A network node according to claim 26, wherein the shared resource includes a set of one or more peripherals and/or memories.

30. A network node according to claim 26, wherein the network node an application specific integrated circuit (ASIC) or other suitable application environment for implementing the two different ways.

31. A network node according to claim 30, wherein the functionality of application specific integrated circuit (ASIC) or other suitable application environment includes video, graphic, cellular or other suitable functionality.

32. A network node according to claim 26, wherein the module allows programmable bandwidth/latency allocation to each thread.

33. A network node according to claim 32, wherein the programmable bandwidth/latency allocation can be dynamically varied at run time.

34. A network node according to claim 32, wherein the operation independent manner includes using time division for priority allocation which is independent of incoming requests, including the priority defined by the operation.

35. A network node according to claim 26, wherein the module uses a first arbitration technique if a current priority parameter of a second arbitration technique does not match.

36. A network node according to claim 35, wherein the module uses a round robin arbitration if any thread does not match a current priority thread identification in a time division priority selection technique.

37. A network node according to claim 28, wherein the time division priority selection technique includes changing in each time slot the priority thread identification so that masters get their turn after a certain period of time.

38. A network node according to claim 28, wherein the time division priority selection technique includes dividing priority slots of a thread as multiple small slots that can be located sequentially or distributed over a whole master frame.

39. A network node according to claim 28, wherein the time division priority selection technique includes using a master frame having multiple slots.

40. A network node according to claim 39, wherein the master frame includes some slots that do not have any priority and thus are used for the round robin arbitration technique.

41. A network node according to claim 39, wherein the master frame is configurable and includes having a variable number of priority slots.

42. A network node according to claim 39, wherein the master frame includes slot sizes that are either one clock cycle, or longer clock cycles to allow at least one operation of a selected master identification, or multiple clock cycles for handling burst or packeted accesses as a single packet or multiple operations, or some combination thereof.

43. A network node according to claim 39, wherein the master frame includes time slots having respective priority identification that are freely programmable, including some master identifications with multiple time slots and others with no time slots.

44. A network node according to claim 39, wherein the master time frame includes multiple priority slots that are programmable in relation to their number, width or other suitable priority slot parameter.

45. A network node according to claim 26, wherein the method includes selecting a maximum/minimum latency, a maximum/minimum bandwidth, or some combination thereof based on a master's requirements.

46. A network node according to claim 28, wherein the time division priority selection technique includes using a priority identification (ID) that is independent of incoming access identifications.

47. A network node according to claim 28, wherein the incoming access identifications include a master identification (ID), a thread identification, or some combination thereof.

48. A network node according to claim 47, wherein a single master has multiple thread identifications (IDs).

49. A network node according to claim 26, wherein the module supports out-of-order responses, which allows freely ordering incoming operations.

50. A network node according to claim 47, wherein the module uses the round robin arbitration technique if there is no outstanding operation for the master identification (ID).

51. A network or system having a network node with a module to arbitrate multiple master requests to the shared resource, characterized in that the module combines two different ways to arbitrate the multiple master requests to the shared resource in an operation independent manner.

52. A network or system according to claim 51, wherein the two different ways comprise a priority arbitration technique and a round robin arbitration technique.

53. A network or system according to claim 52, wherein the priority arbitration technique comprises a time division priority selection technique.

54. A network or system according to claim 51, wherein the shared resource includes a set of one or more peripherals and/or memories.

55. A network or system according to claim 51, wherein the network node an application specific integrated circuit (ASIC) or other suitable application environment for implementing the two different ways.

56. A network or system according to claim 55, wherein the functionality of application specific integrated circuit (ASIC) or other suitable application environment includes video, graphic, cellular or other suitable functionality.

57. A network or system according to claim 51, wherein the module allows programmable bandwidth/latency allocation to each thread.

58. A network or system according to claim 57, wherein the programmable bandwidth/latency allocation can be dynamically varied at run time.

59. A network or system according to claim 57, wherein the operation independent manner includes using time division for priority allocation which is independent of incoming requests, including the priority defined by the operation.

60. A network or system according to claim 51, wherein the module uses a first arbitration technique if a current priority parameter of a second arbitration technique does not match.

61. A network or system according to claim 60, wherein the module uses a round robin arbitration if any thread does not match a current priority thread identification in a time division priority selection technique.

62. A network or system according to claim 53, wherein the time division priority selection technique includes changing in each time slot the priority thread identification so that masters get their turn after a certain period of time.

63. A network or system according to claim 53, wherein the time division priority selection technique includes dividing priority slots of a thread as multiple small slots that can be located sequentially or distributed over a whole master frame.

64. A network or system according to claim 53, wherein the time division priority selection technique includes using a master frame having multiple slots.

65. A network or system according to claim 64, wherein the master frame includes some slots that do not have any priority and thus are used for the round robin arbitration technique.

66. A network or system according to claim 64, wherein the master frame is configurable and includes having a variable number of priority slots.

67. A network or system according to claim 64, wherein the master frame includes slot sizes that are either one clock cycle, or longer clock cycles to allow at least one operation of a selected master identification, or multiple clock cycles for handling burst or packeted accesses as a single packet or multiple operations, or some combination thereof.

68. A network or system according to claim 64, wherein the master frame includes time slots having respective priority identification that are freely programmable, including some master identifications with multiple time slots and others with no time slots.

69. A network or system according to claim 64, wherein the master time frame includes multiple priority slots that are programmable in relation to their number, width or other suitable priority slot parameter.

70. A network or system according to claim 51, wherein the method includes selecting a maximum/minimum latency, a maximum/minimum bandwidth, or some combination thereof based on a master's requirements.

71. A network or system according to claim 53, wherein the time division priority selection technique includes using a priority identification (ID) that is independent of incoming access identifications.

72. A network or system according to claim 53, wherein the incoming access identifications include a master identification (ID), a thread identification, or some combination thereof.

73. A network or system according to claim 72, wherein a single master has multiple thread identifications (IDs).

74. A network or system according to claim 51, wherein the module supports out-of-order responses, which allows freely ordering incoming operations.

75. A network or system according to claim 72, wherein the module uses the round robin arbitration technique if there is no outstanding operation for the master identification (ID).

76. A computer program product with a program code, which program code is stored on a machine readable carrier, for carrying out the steps of a method comprising the steps of:
combining two different ways to arbitrate the multiple master requests to the shared resource in an operation independent manner, when the computer program is run in a module of either user equipment, a network node, or some combination thereof.

77. A method according to claim 1, wherein the method further comprises implementing the step of the method via a computer program running in a processor, controller or other suitable module in a network node or element.
